(19) United States
(12) Patent Application Publication
(10) Pub. No.: US 2004/0263315 A1
(43) Pub. Date: Dec. 30, 2004

(54) Information security system interworking with entrance control device and control method thereof

(76) Inventors: Sangbum Kim, Seoul (KR); Kiyong Lee, Gyeonggi-do (KR); Junkyun Yo, Seoul (KR); Jincheon Kim, Seoul (KR)

Correspondence Address: JONES DAY, 222 EAST 41ST ST, NEW YORK, NY, 10017, US

(21) Appl. No.: 10/866,592

(22) Filed: Jun. 11, 2004

(30) Foreign Application Priority Data
Jun. 30, 2003 (KR) 2003-43942

(51) Int. Cl. G05B 19/00

(52) U.S. Cl. 340/5.7

(57) ABSTRACT

An information security system interworking with an entrance control device and a control method thereof are disclosed. The system comprises: an entrance control device for extracting authentication information of the person to transmit the extracted authentication information, and controlling an opening/closing of at least one gate; an interworking server for receiving the authentication information to perform authentication, storing an entrance event, and transmitting information of the person when the authentication is successful; a computer resource control server for receiving the information of the person to search for information of a user's computer resource, and generating a security lock set signal or a security lock release signal to transmit the generated security lock set signal or security lock release signal to the user's computer resource; and a computer resource unit including at least one computer resource for receiving the security lock set signal or security lock release signal to switch the system to a security lock state or a security lock release state.

### BACKGROUND OF THE INVENTION

1. Field of the Invention

The present invention relates to an information security system interworking with an entrance control device and a control method thereof, and more particularly to an information security system which inter-works with an entrance control device managing entrance permission by checking personal information of a person who wishes to access to a building or an office, receives authentication information regarding the person identified from the entrance control device, assigns or deprives access right for communication devices, and performs real-time monitor for operations such as generation, deletion, move, or copy of information performed by a operating communication device, and a control method thereof.

2. Description of the Prior Art

In a modernized society, various entrance control devices are widely used in various places such as general homes, government agencies, or companies. Various types of entrance control devices are manufactured and used, from a simple lock device of a low price, to a mechanical device or an electronic device with a high price in which mechanical mechanism and electronic technology are combined.

Typically, an entrance control device having a magnetic card, on which a magnetic stripe is attached, has been widely used. However, at present, such an entrance control device is not often used because of malfunction due to damage of the magnetic stripe and an illegal copy of the magnetic card. Thus, the current entrance control device in popular use is an entrance control device employing a radio frequency (hereinafter, referred to as an RF) card, which has advantages in that it has a relatively low system construction cost and superior security. Further, an entrance control device using an integrated circuit (hereinafter, referred to as an IC) card embedding IC chip has been widespread. However, in spite of such many advantages, they have a disadvantage in that it exacts a high system construction cost.

In order to improve security performance of these various entrance control devices, other types of entrance control devices have been developed and used, which employ biometrics recognition technology such as fingerprint recognition, iris recognition, palm recognition, vein recognition, voice recognition, or image recognition. The entrance control device using such biometrics recognition technology presents high security because the system is difficult to imitate or duplicate, in comparison with a recognition method of commonly used entrance control devices. However, such an entrance control device using the biometrics recognition technology requires a large construction cost and is not perfect in terms of recognition speed, recognition success rate, or malfunctioning due to inherent characteristics of the biometrics technology. Therefore, it has not become popular.

Meanwhile, when higher security is required, a multi-step verification process may be requested for a person wishing to access, by employing various kinds of recognition modules. For instance, an entrance control device may be constructed by using both a card recognition method and a fingerprint recognition method in tandem. Since the person wishing to access passes through the multi-step verification process, the entrance control device may presents the higher security.

However, various conventional entrance control devices have only been concentrated on a simple entrance control function of controlling the incoming and outgoing of an unauthorized person. That is, the main target of such entrance control devices is to eliminate inefficiency such as work disturbance, deterioration of work continuity, or time loss due to incoming and outgoing of unauthorized persons.

Meanwhile, with the development of wired communication environments, information-security-related accidents frequently occur, in which illegal access to another person's computer is committed through an external communication network and programs or various information stored in the computer are stolen. Such accidents occur not only on the on-line through a communication network, but also on the off-line, where it is possible to illegally access another person's computer. That is, after illegal access to another person's computer is committed by way of off-line method, data may be copied to various data storage media (e.g., floppy disks or CD-ROMs) or data may be illegally transmitted to an external computer by way of on-line method.

Particularly, in a case of a computer system in a company, a government or public offices, blind points frequently occur in the system due to increase of devices, such as computers which constitute the system and users therefor. For instance, cases frequently occur, in which even an authorized user maliciously drains out information to another person, either online or offline. Further, since most of current security systems are not a multi-phased security system in which a computer system permitting access of a predetermined user or a user group is constructed, important confidential documents or company information may be stolen by only a single user to thereby bring about a fatal damage.

In brief, the conventional entrance control device provides only a simple entrance control function through authentication of the person trying access, and the conventional information security system does not provide a function capable of preventing from espionage when a spy accesses a computer on the off-line. Furthermore, an environment has not been constructed that can perform real-time monitoring of forgery, falsification, deletion, or transmission of various secret data committed by an authorized person on the information security system.

### SUMMARY OF THE INVENTION

Accordingly, the present invention has been made to solve the above-mentioned problems occurring in the prior art, and an object of the present invention is to provide an information security system which inter-works with an entrance control device managing entrance permission by checking the personal information of a person wishing access to a building or an office, receives authentication information regarding the person identified from the entrance control device, assigns or deprives access right for a communication apparatus carried in the person, and monitors in real time an operation such as generation, deletion, moving, or copying of information performed by a driven communication apparatus, and a control method thereof.

In order to accomplish this object, there is provided an entrance control-based information security system for operating an information security system by using authentication information associated with a passenger who tries to gain access, the information security system comprising: an entrance control device for extracting authentication information of the passenger to transmit extracted authentication information, and controlling an opening/closing of at least one gate; an interworking server for receiving the authentication information to perform authentication, storing an entrance event, and transmitting information of the passenger when the authentication is successful; a computer resource control server for receiving the information of the passenger to search for information of a user's computer resource, and generating a security lock set signal or a security lock release signal to transmit a generated security lock set signal or a generated security lock release signal to the user's computer resource; and a computer resource unit including at least one computer resource for receiving the security lock set signal or security lock release signal to switch the system to a security lock state or a security lock release state.

In order to accomplish this object, there is provided a method for use in operating an entrance control-based information security system including an entrance control device, an interworking server for identifying a passenger trying to gain access, a computer resource control server, a computer resource unit having at least one computer resource, the entrance control device extracting authentication information of the passenger and controlling an opening/closing of a gate, the computer resource control server generating a security lock set signal or a security lock release signal and transmitting the generated signal to a person's computer resource, the method comprising the steps of: a) receiving the authentication information of the passenger from the interworking server when an entrance event occurs in the entrance control device; b) determining whether or not the passenger is identified by means of the authentication information; c) searching for computer resource information assigned to the passenger; and d) transmitting the security lock set signal or the security lock release signal to the person's computer resource by using the computer resource information.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically showing a construction of an entrance control-based information security system interworking with an entrance control device according to a preferred embodiment of the present invention;

FIG. 2 is a flowchart illustrating a process in which a person's computer resource is driven by means of entrance information in an entrance control-based information security system according to an embodiment of the present invention; and

FIG. 3 is a flowchart illustrating a process of determining entrance authority and whether or not an entrance event is proper and managing an entrance in an entrance control-based information security system according to an embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same elements as those in other drawings. In the following description of the present invention, a detailed description of known configurations and functions incorporated herein will be omitted when it may make the subject matter of the present invention rather unclear.

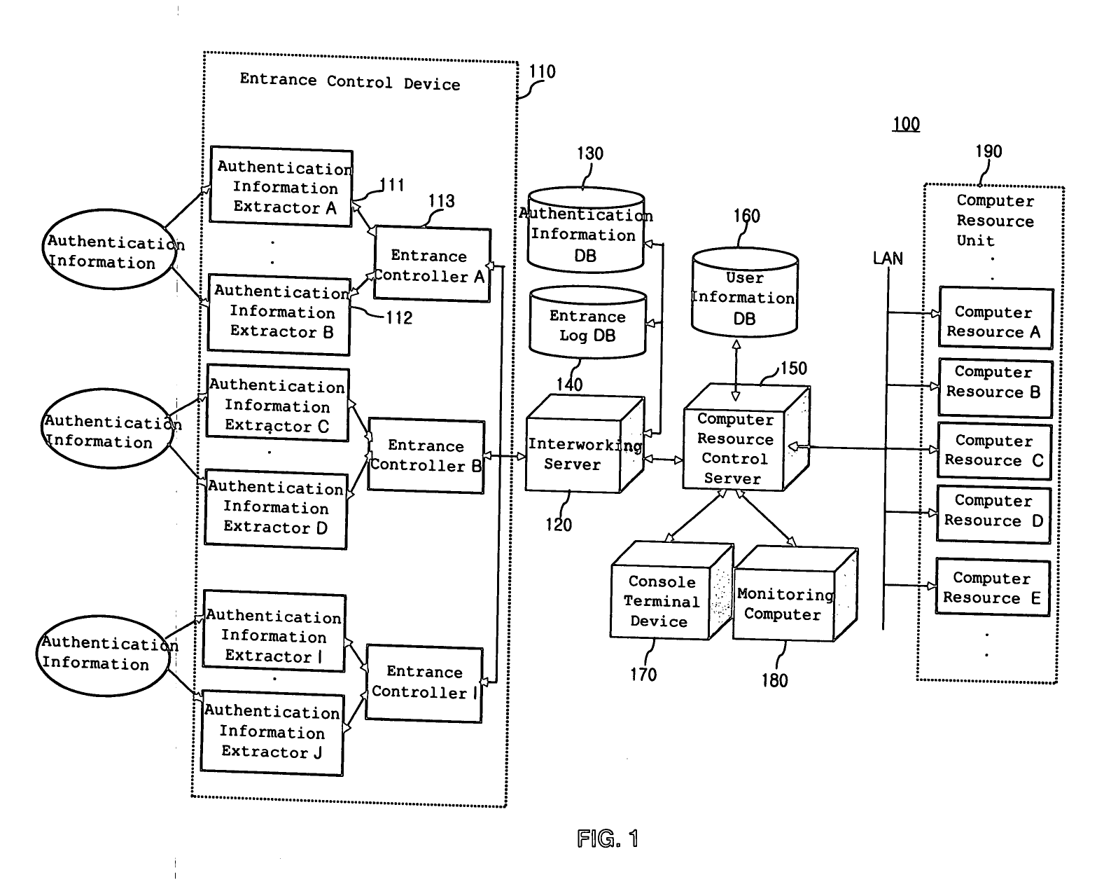

FIG. 1 is a block diagram schematically showing a construction of an entrance control-based information security system 100 interworking with an entrance control device according to a preferred embodiment of the present invention.

The entrance control-based information security system 100 according to an embodiment of the present invention includes an entrance control device 110, an interworking server 120, an authentication information database 130, an entrance log database 140, a computer resource control server 150, a user information database 160, a console terminal device 170, a monitoring computer 180, and a computer resource unit 190.

The entrance control device 110 identifies a user coming into and going out of a building in which an entrance control-based information security system is installed, determines whether to permit the entrance of the user and controls the entrance. Such an entrance control device 110 includes a plurality of authentication information extractors 111 and 112 and an entrance controller 113 and may identify a person coming into and going out of at least one gate.

The authentication information extractors 111 and 112 extract authentication information from the person and may be variously constructed according to the kinds of the authentication information or a medium containing the authentication information. For instance, where the medium containing the authentication information is a card, the extractor becomes a card reader. Further, when the authentication information is fingerprint, the extractor becomes a fingerprint scanner. The authentication information extractor 111 or 112 according to an embodiment of the present invention may include various card readers such as an IC card reader, a magnetic card reader and a RF card reader or a fingerprint reader. In addition, the authentication information extractor may include an iris reader, a palm reader, a vein reader, a voice reader, or an image reader. These authentication information extractors 111 and 112 are installed at gates of each floor and gates of each office as well as around gates in building and may perform double or triple steps of authentications against an accessing person.

Further, the authentication information extractors 111 and 112 transmit an extracted authentication information to the entrance controller 113.

The entrance controller 113 transmits the authentication information received from the authentication information extractors 111 and 112 to the interworking server 120 which will be described later, and controls an opening and closing of a gate by using response data received from the interworking server 120. In order to control the opening and closing of the gate, the entrance controller 113 controls an electronic or mechanical door lock and a door sensor attached at the gate.

The interworking server 120 receives the authentication information from at least one entrance controller 113, searches for authentication information stored in the authentication information database 130, compares the received authentication information with the searched authentication information, and identifies entrance or exit. That is, when the authentication information received from the entrance controller 113 is registered in the authentication information database 130 as legitimate authentication information, entrance is permitted. Otherwise, entrance trial is not allowed.

Further, when entrance of the person is permitted, the interworking server 120 transmits authentication information associated with the person (e.g., ID, name, or entrance event information) to the computer resource control server 150. Herein, the entrance event information includes information regarding the fact that entrance authentication has been requested, information regarding a gate code and time at which an entrance event has occurred, and information regarding whether to permit entrance.

Meanwhile, the authentication information database 130 stores the authentication information of a user who has an authority to enter a building at which the entrance control-based information security system has been installed. Herein, the authentication information of the user may include a card number, fingerprint, iris, vein, palm, voice, or image data. Further, the authentication information database 130 stores gate code information for permitting access of registered users, so that the system may control specific access of a user according to each floor and each office.

The entrance log database 140 stores the aforementioned entrance event information according to each person wishing to access or per time of the access, and stores code information regarding a gate to which a user has last gained access. The latest gate code information is used in preventing the authentication information of the user from being doubly used due to forgery, copy, or leakage. For instance, when the authentication information of the user entering a building is reused as authentication information for entering the inside of the building, or when the authentication information of the user entering an inside of a predetermined office is reused as authentication information for entering an inside of a building or an inside of other office, the interworking server 120 determines the authentication information of the user as illegal authentication information, and does not permit entrance.

Meanwhile, the authentication information database 130 and the entrance log database 140 described in FIG. 1 may be integrated into one database where appropriate.

The computer resource control server 150 receives ID or name information of the person from the interworking server 120, searches for the user information database 160 by means of the received ID or name information of the person wishing to gain access. The computer resource control server 150 extracts a computer resource IP address and/or a computer resource code, which are set for the person wishing to gain access, by searching for the user information database 160. Then, the computer resource control server 150 transmits a lock set signal or a lock release signal to a corresponding computer resource, or transmits a secondary authentication wait signal for receiving authentication information. The computer resource having received the lock release signal is turned into a stand-by state in which it can be used even without passing through an additional authentication process.

Herein, the computer resource represents various electronic devices (e.g., computer) connected to the computer resource control server 150 for use by an accessing person. Further, a secondary authentication refers to a process in which secondary authentication information is received and identified so that the person may use the computer resource. Herein, it is preferred that the secondary authentication information is a log-in information containing an ID and password of the person, public key information based on a public key infrastructure, and card information such as a card number.

The user information database 160 stores IP address information and code information of a computer resource set in by a user on the basis of an ID or name of the user. Herein, the computer resource set in by the user represents a computer resource access right of which is assigned to the user.

The console terminal device 170 enables or disables an authority to access each computer resource per each user or per each group of users, or sets an Internet use standard, so that it may set and manage Internet surfing time and a visiting site per each computer resource. In order to perform these tasks, the console terminal device 170 stores a predetermined computer resource management program. The computer resource management program sets or releases one or more permitted users (main users and sub-users) per each computer resource. In addition, the computer resource management program performs a real-time monitor of hardware information modified in each computer resource system. Furthermore, the computer resource management program sets a file type, such as e.g., .txt, .doc, .ppt, .hwp, .xls, or .pdf, which may be used in each computer resource according to each user or each group.

The monitoring computer 180 is a computer controlled by a manager and provides a system state monitoring function capable of monitoring an on state, an off state, a log-in state, a log-out state, log-in time of each computer resource connected to the computer resource control server 150, and a file monitoring function capable of monitoring a file use status such as generation, deletion, moving, or copying of a file in each computer resource. Further, the monitoring computer 180 provides a network state monitoring function capable of performing a real-time monitoring of access permission or access denial for a user who gained access to a system through a port.

Further, the monitoring computer 180 provides an encryption/decryption state monitoring function capable of performing a real-time monitoring of file encryption processes and/or file decryption processes in all computer resources, and a website monitoring function capable of monitoring the status of an inaccessible website according to each user or each group. Furthermore, the monitoring computer 180 provides an entrance log monitoring function capable of monitoring the moving status of users in a building and checked position information (code information regarding a gate through which a user has last gone). In order to perform these functions, the monitoring computer 180 stores a predetermined monitoring program therein.

The computer resource unit 190 includes a plurality of computer resources and is connected to the computer resource control server 150. The computer resource unit 190 may be constructed by at least one computer resource in which access right or Internet use conditions are set for each group. Each computer resource contained in the computer resource unit 190 gathers information regarding a person approaching each computer resource and displays the gathered information. Herein, information of an accessing person refers to information regarding date and time of access, IP address information of the accessing person, and name of the accessing person or name of a group containing the accessing person. Further, the computer resource unit 190 traces a position of the accessing person by using an IP tracing program, and checks and displays a state of a packet transceived through a network.

Each computer resource contained in the computer resource unit 190 sets a lock to the system or releases the set lock according to the lock set signal or the lock release signal transmitted from the computer resource control server 150. Further, each computer resource receives the secondary authentication wait signal from the computer resource control server 150, and loads and displays an authentication information input screen for inputting the secondary authentication information from a user.

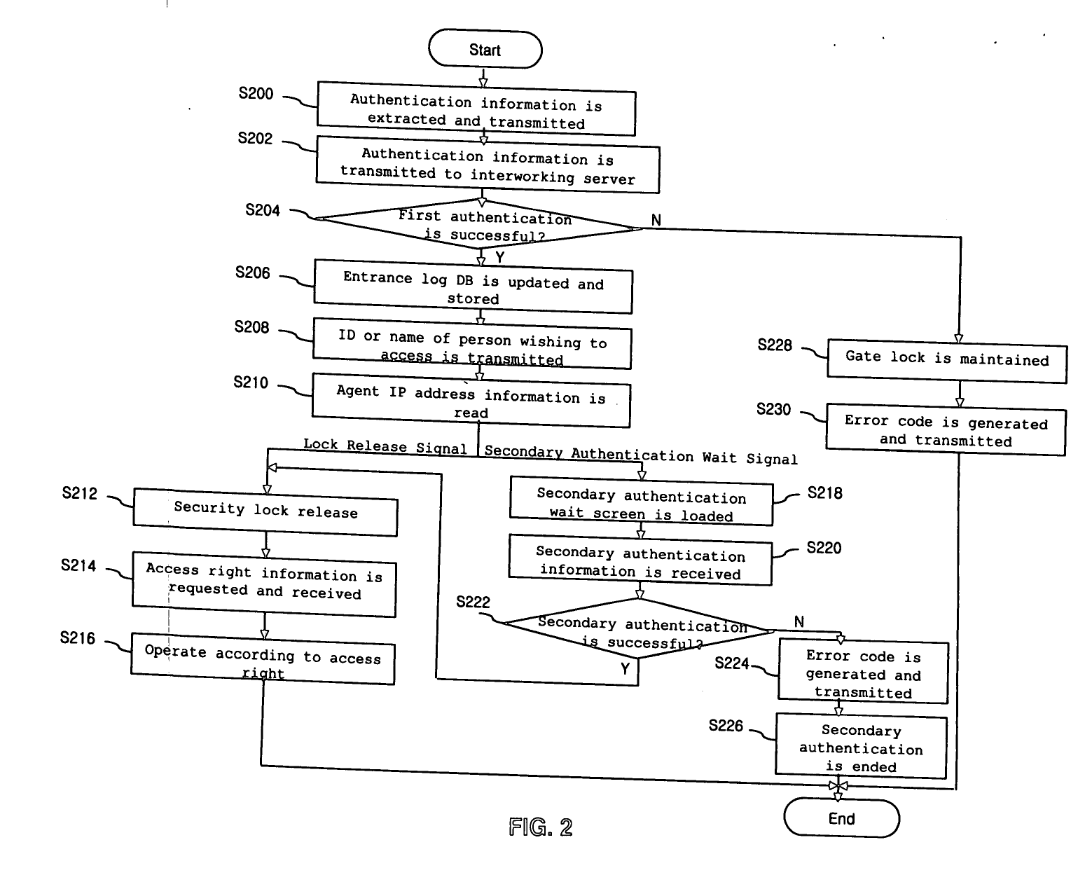

FIG. 2 is a flowchart illustrating a process in which a person's computer resource is driven by means of entrance information in an entrance control-based information security system according to an embodiment of the present invention.

The authentication information extractors 111 and 112, which are installed about a gate of a building at which the entrance control-based information security system according to an embodiment of the present invention is installed, extract authentication information from the person wishing to access, and transmit the extracted authentication information to the entrance controller 113 at step 200. The entrance controller 113 transmits the authentication information received from the authentication information extractors 111 and 112 to the interworking server 120 at step 202.

The interworking server 120 having received the authentication information searches for registered authentication information stored in the authentication information database 130 and performs a first authentication operation at step S204. From the result of the determination step S204, when it is determined that the first authentication operation is successful, the interworking server 120 instructs the entrance controller 113 to open a gate, updates entrance event information, and stores the updated entrance event information in the entrance log database 140 at step 206. Herein, the entrance event information represents information regarding a gate code at which an entrance event has occurred, entrance event occurrence time, the kind (out event or in event) of the entrance event, and whether or not authentication was successful.

The interworking server 120 having successfully performed the authentication transmits ID or name information of the person to the computer resource control server 150 at step 208. The computer resource control server 150 having received the ID or name information searches for IP address information of a computer resource set in the person from the user information database 160 and reads the IP address information at step 210. Herein, in an embodiment of the present invention, at least one user may be set as a main user or a sub-user in one computer resource. Further, when a user enters an inside of a building, a computer resource in which a security lock is released or a computer resource operating in a secondary authentication wait state may be separately set.

The computer resource control server 150 having read the IP address information of the person may transmit a lock release signal or a secondary authentication wait signal to a corresponding computer resource according to a certain setting. When the lock release signal is transmitted, a security lock of the corresponding computer resource is released at step S212. Herein, the release of the security lock means that when a computer resource is a personal computer (PC), a booting operation is performed, so that the personal computer is switched to a usable state.

The person's computer resource in which the security lock is released requests access right information to the computer resource control server 150 and receives the access right information at step S214. That is, the computer resource control server 150 which is required to output the access right information searches for the user information database 160 by means of the IP address information of the computer resource or code information, and extracts the access right information to transmit the extracted access right information to a corresponding computer resource. The computer resource having received the access right information operates according to a access right at step 216. Herein, the expression “the computer resource operates according to the access right” signifies that the computer resource performs or does not perform the labor requested by the user according to its authority in relation to acquisition, reading, generation, change, deletion, moving, or copying of various information.

Meanwhile, when the computer resource control server 150 generates and transmits the secondary authentication wait signal, the person's computer resource having received the secondary authentication wait signal loads and displays a secondary authentication wait screen at step S218. The person's computer resource receives secondary authentication information transmitted from a predetermined data input apparatus at step S220. Herein, the predetermined data input apparatus may include various bio data readers as well as a keyboard and a card reader.

The person's computer resource determines whether or not a secondary authentication is successful by means of the secondary authentication information at step S222. As a result of the determination, when the secondary authentication is determined as success, step 212 is performed. Otherwise, the person's computer resource generates an error code to transmit the generated error code to the computer resource control server 150 at step S224. The computer resource control server 150 receiving the error code stores the received error code in the user information database 160.

The person's computer resource may perform a secondary authentication for a predetermined number of times, and ends the secondary authentication when the secondary authentication is failed for the predetermined number of times at step S226. In contrast, when the secondary authentication is successfully performed within the predetermined number of times, step 212, in which a set security lock is released, is performed.

Meanwhile, when the first authentication is determined as failure at step 204, the interworking server 120 transmits an authentication failure code to a corresponding entrance controller 113 and controls a gate lock state to be maintained at step S228. Then, the interworking server 120 generates an error code to transmit the generated error code to the computer resource control server 150, and the computer resource control server 150 stores the received error code in the user information database 160 at step S230.

An operation process of the entrance control-based information security system when the person wishing to access enters an inside of a building has been described with reference to FIG. 2. Further, even when the person goes to an outside of a building, an entrance event is processed through a process similar to the case in FIG. 2 and a security lock is set in a corresponding computer resource.

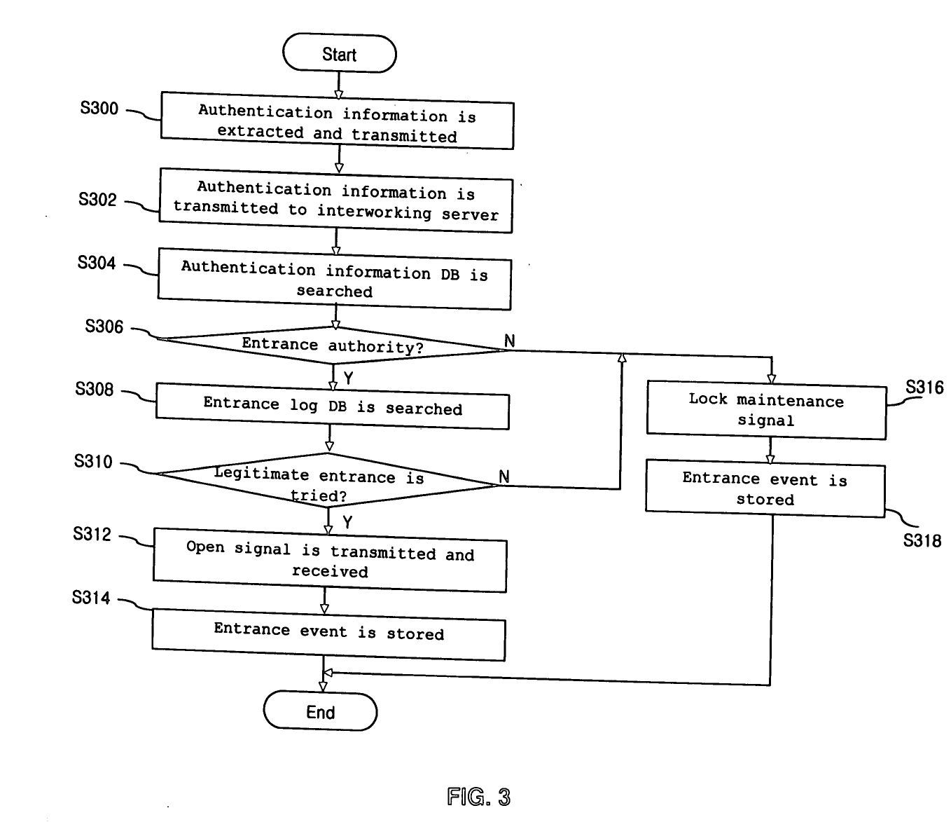

FIG. 3 is a flowchart illustrating a process of determining access right and whether or not an entrance event is proper and managing an entrance in an entrance control-based information security system according to an embodiment of the present invention.

For the purpose of illustration, it is assumed that a user stays inside of a building. The authentication information extractors 111 and 112 extract authentication information about the user who wants to pass through a predetermined gate on the inside of the building and transmits the extracted authentication information to the entrance controller 113 at step 300. The entrance controller 113 transmits the received authentication information to the interworking server 120 at step 302.

The interworking server 120 having received the authentication information searches for the authentication information database 130 at step 304 and determines whether or not authority to enter a corresponding gate is assigned to the user at step 306. From the result of the determination at step 306, when it is determined that the user has the entrance authority, the interworking server 120 searches for the entrance log database 140 at step 308. The interworking server 120 having searched for the entrance log database 140 judges whether or not an entrance event is proper at step 310, and transmits an open signal to the entrance controller 113 when it is determined that the entrance event is proper, at step 312. The entrance controller 113 having received the open signal controls a lock of a door lock of a corresponding gate to be released and opens the gate. The interworking server 120 having transmitted the open signal stores entrance event information in the entrance log database 140 at step 314.

Herein, the proper entrance event refers to a case in which the authentication information of a user having requested entrance is available for authentication information at a corresponding gate. For instance, when the authentication information of a user is used for a place in the building, in which the user is currently located and which is different from the corresponding location proper for the authentication information of the user, the entrance event is improper. That is, the improper entrance event may occur in a case in which the authentication information of the user has been forged, copied, or stolen.

When it is determined that a user has entrance authority or when the entrance event is improper, the interworking server 120 transmits a lock maintenance signal to a corresponding entrance controller 113 at step 316. Further, the interworking server 120 having transmitted the lock maintenance signal stores a corresponding entrance event in the entrance log database 140 at step 318.

As described above, the conventional entrance control device provides a simple entrance control function but does not inter-work with an information security system. However, according to the present invention, an information security system allows only a legitimate person wishing to access to access a computer resource while maintaining compatibility with a typical entrance control device, thereby raising information security.

Further, according to the present invention, a position of a user is identified by means of code information of a gate through which the user goes into and out of, so that illegal entrance events, which may occur due to forgery, copy, or stealing of authentication information, can effectively be blocked.

Furthermore, the present invention assigns access right to a computer resource of a user, blocks access to a file or system to which the access right is not assigned, performs real-time monitoring of the computer resource and monitors generation, change, deletion, and moving of the file, thereby preventing a security accident, such as an illegal stealing or destruction of information.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An entrance control-based information security system for operating an information security system by using authentication information associated with a passenger who tries to gain access, the information security system comprising:
an entrance control device for extracting authentication information of the passenger to transmit extracted authentication information, and controlling an opening/closing of at least one gate;
an interworking server for receiving the authentication information to perform authentication, storing an entrance event, and transmitting information of the passenger when the authentication is successful;
a computer resource control server for receiving the information of the passenger to search for information of a user's computer resource, and generating a security lock set signal or a security lock release signal to transmit a generated security lock set signal or a generated security lock release signal to the user's computer resource; and
a computer resource unit including at least one computer resource for receiving the security lock set signal or security lock release signal to switch the system to a security lock state or a security lock release state.

2. The system according to claim 1, wherein the entrance control device includes a door lock installed at each gate, a door sensor for detecting whether or not an opening and a closing of said each gate is performed, an authentication information extractor for extracting and transmitting the authentication information, and an entrance controller for receiving the authentication information and transmitting the security lock set signal or the security lock release signal to the door lock.

3. The system according to claim 1, wherein the authentication information includes at least one kind of information from among digital authentication information recorded in a magnetic card, a radio frequency card, and an integrated circuit, and bio authentication information such as a fingerprint, an iris, a palm, a vein, a voice, and an image of the passenger.

4. The system according to claim 2 or 3, wherein the authentication information extractor includes at least one kind of reader from among a magnetic card reader, a radio frequency card reader, an integrated circuit reader, a fingerprint reader, an iris reader, a palm reader, a vein reader, a voice reader, and an image reader.

5. The system according to claim 1, wherein the interworking server inter-works with an authentication information database for storing the authentication information of the passenger registered in the entrance control-based information security system, and an entrance log database for storing the entrance event at each gate.

6. The system according to claim 1, wherein the computer resource control server inter-works with a user information database for storing code information and Internet protocol information of at least one computer resource assigned per each registered passenger, and access right information set per each registered passenger.

7. The system according to claim 1, wherein the computer resource control server inter-works with a console terminal device for enabling and disabling entrance authority of each computer resource, Internet usable time, access right to inaccessible website and file according to each registered passenger or each group including a plurality of registered passenger.

8. The system according to claim 1, wherein the computer resource control server inter-works with a monitoring computer including a system state monitoring function capable of monitoring an on state, an off state, a log-in state, a log-out state, log-in time of each computer resource, a file monitoring function capable of monitoring a file use status such as generation, deletion, moving, or copying of a file in each computer resource, a network state monitoring function capable of monitoring access permission information or access denial information for a communication apparatus which gains access to the entrance control-based information security system, an encryption/decryption state monitoring function capable of monitoring a file encryption process and/or a file decryption process in each computer resource, a website monitoring function capable of monitoring status of an inaccessible website according to each passenger or each group, and an entrance log monitoring function capable of monitoring move status of the passenger in a building and checked position information.

9. The system according to claim 1, wherein the computer resource has a function of performing a passenger authentication by means of at least one kind of information from among a passenger authentication, a password, public key information based on a public key infrastructure, and digital authentication information transmitted from the authentication information extractor.

10. A method for use in operating an entrance control-based information security system including an entrance control device, an interworking server for identifying a passenger trying to gain access, a computer resource control server, a computer resource unit having at least one computer resource, the entrance control device extracting authentication information of the passenger and controlling an opening/closing of a gate, the computer resource control server generating a security lock set signal or a security lock release signal and transmitting the generated signal to a person's computer resource, the method comprising the steps of:
a) receiving the authentication information of the passenger from the interworking server when an entrance event occurs in the entrance control device;
b) determining whether or not the passenger is identified by means of the authentication information;
c) searching for computer resource information assigned to the passenger; and
d) transmitting the security lock set signal or the security lock release signal to the person's computer resource by using the computer resource information.

11. The method according to claim 10, wherein, at step a), the entrance control device extracts the authentication information to transmit extracted authentication information to the interworking server when the entrance event occurs.

12. The method according to claim 10, whereat step b) including the sub-steps of:
b1) determining whether or not the passenger has a legitimate entrance authority at a gate at which the entrance event has occurred by using the authentication information; and
b2) determining whether or not the entrance event is a legitimate entrance event when the passenger has a legitimate entrance authority.

13. The method according to claim 12, wherein, at step b2), the interworking server recognizes code information regarding a gate through which the passenger has last passed and information regarding whether or not passage is performed, determines whether or not the authentication information is used at the gate at which the entrance event has occurred, and determines whether or not the entrance event is legitimate.

14. The method according to claim 10, wherein, at step c), the computer resource information includes IP address information and code information of the person's computer resource having a security lock which has been set to be enabled or disabled according to entrance or exit of the passenger.

15. The method according to claim 10, wherein, at step d), the computer resource control server transmits the security lock set signal when the entrance event is a going-out event in which the passenger passes through a gate and deviates from a building or a predetermined zone of the building, and transmits the security lock release signal when the entrance event is a coming-in event.

16. The method according to claim 10, wherein, at step d), the computer resource control server transmits a secondary authentication wait signal, the secondary authentication wait signal allowing a secondary authentication to be performed in the person's computer resource, to the person's computer resource.

17. The method according to claim 16, wherein the passenger's computer resource having received the secondary authentication wait signal receives secondary authentication information, and loads and displays a secondary authentication wait screen through which a log-in operation is performed.

18. The method according to claim 16, wherein the secondary authentication information includes at least one kind of information from among an ID, a password, public key information, digital authentication information transmitted from an authentication information extractor connected to the passenger's computer resource in wire/wireless manner, and a card number for authentication.

19. The method according to claim 10 or 18, wherein the passenger's computer resource, which has received the security lock release signal or has successfully performed the secondary authentication, requests access right information of the passenger to the computer resource control server, receives the access right information, and operates according to the access right information.

20. The method according to claim 19, wherein the access right information contains information on a possibility of at least one labor from among labors relating to acquisition, reading, generation, change, deletion, moving, or copying of various information, which the passenger can perform by means of the passenger's computer resource.
